(19) United States
(12) Patent Application Publication
(10) Pub. No.: US 2014/0155794 A1
(43) Pub. Date: Jun. 5, 2014

(54) Massage Device and Method

(71) Applicant: Yana Marie Tambakis, North Bondi (AU)

(72) Inventor: Yana Marie Tambakis, North Bondi (AU)

(21) Appl. No.: 14/097,139

(22) Filed: Dec. 4, 2013

(30) Foreign Application Priority Data
Dec. 5, 2012 (AU) 2012261511

(51) Int. Cl. A61H 11/00

(52) U.S. Cl. CPC A61H 11/00
USPC 601/137

(57) ABSTRACT

A massage device for self-massage by a user. The device including: a body defined by an elongate element adapted to form a closed loop; and a plurality of massage elements located spaced apart along the elongate element such that each one of the plurality of massage elements can be substantially used in isolation; each of the plurality of massage elements having a massage portion being inwardly directed with respect to the closed loop and an outwardly directed abutment portion with respect to the closed loop; each massage element being coupled about the midsection to the elongate element; and each one of the plurality of massage elements having a respectively different configuration. An embodiment device including at least two massage elements, each including a respective massage portion having a different effective massage size.

### FIELD OF THE INVENTION

The present invention relates to massage devices and in particular to massage devices for use in self-massage.

The invention has been developed primarily for use as a massage device and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

Know massage devices typically have a single purpose and/or require configuration for enabling selective self massage. A user is typically required to directly hold and/or position the massage device proximal to the location being massaged.

There is a need in the art for improved and/or alternative massage devices.

### OBJECT OF THE INVENTION

It is an object of the present invention to overcome or ameliorate at least one of the disadvantages of the prior art, and to provide a useful alternative.

It is an object of the invention in its preferred form to provide a massage device that can be used to perform self-massage.

### SUMMARY OF THE INVENTION

According to an aspect of the invention there is provided a massage device for self-massage by a user, the device including:
a body defined by an elongate element adapted to form a closed loop; and
a plurality of massage elements located spaced apart along the elongate element.

Preferably, the body is defined by a flexible elongate element. More preferably, the body is adapted to form a size adjustable closed loop. Most preferably, the body has two ends which may be coupled to form a size adjustable closed loop.

Preferably, each one of the plurality of massage elements is spaced for isolated use. More preferably, each one of the plurality of massage elements having a respectively different configuration.

Preferably, the plurality of massage elements are inwardly facing with respect to the closed loop.

Preferably, the closed loop is sized to fit around the user's torso. More preferably, the plurality of massage elements are spaced apart along the elongate element. Most preferably, each one of the plurality of massage elements is spaced for isolated use.

Preferably, the body includes a pair of coupling elements for adjoining ends of the elongate element to form the closed loop. Alternatively, ends of the elongate element are preferably fixedly adjoined to form the closed loop. Alternatively, the body is preferably integrally formed as the closed loop.

Preferably, one or more of the plurality of massage elements are fixedly coupled to the elongate element. Preferably, or alternatively, one or more of the plurality of massage elements are integrally formed with the body.

Preferably, the plurality of massage elements include massage elements of different sizes. More preferably, the plurality of massage elements include massage elements of different shapes. Most preferably, each of the plurality of massage elements are of different sizes and/or shapes.

Preferably, the elongate element is flexible. More preferably, the elongate element is resilient. Most preferably, the elongate element is substantially non-elastic.

Preferably, the elongate element is a peripheral elongate band element forming a closed loop having an inwardly directed surface and an outwardly directed surface. More preferably, the plurality of massage elements are located to be inwardly directed from the inwardly directed surface. Most preferably, the band element is substantially non-elastic.

Preferably, a massage element has an outwardly directed abutment portion opposite an inwardly directed massage portion with respect to the elongate element. More preferably, the outwardly directed abutment portion protrudes outwardly from the body. Most preferably, the inwardly directed massage portion protrudes inwardly from the body.

According to an aspect of the invention there is provided a method of self-massage by a user, the method including the steps of:
(a) providing a device comprising a flexible body forming a closed loop having a plurality of spaced massage elements;
(b) locating the body closed loop around the user (for example the user's torso, leg or arm);
(c) locating a selected one of the plurality of massage elements at a desired location on the user (for example the user's back, shoulder, thigh, hip, foot, trapezius, pectoral);
(d) applying tension to the body such that the selected massage element is pulled into massage engagement with the location on the user; thereby to produce a massaging effect on the user by exerting localized pressures and/or friction.

According to an aspect of the invention there is provided a method of self-massage by a user, the method including the steps of:
(a) providing a device comprising a flexible body forming a closed loop having a plurality of spaced massage elements;
(b) locating the body closed loop around the user (for example the user's torso, leg or arm);
(c) locating a selected one of the plurality of massage elements at a desired location on the user (for example the user's back, shoulder, thigh, hip, foot, trapezius, pectoral);
(d) applying pressure to a selected one of the plurality of massage elements by rolling and/or pressing it against the wall or floor, such that the selected massage element is pushed into massage engagement with the location on the user; thereby to produce a massaging effect on the user by exerting localized pressures and/or friction.

According to an aspect of the invention there is provided a massage device for self-massage by a user, the device including:
a body defined by a flexible elongate element adapted to form a closed loop; and
a plurality of massage elements located spaced apart along the elongate element;
each one of the plurality of massage elements having a respectively different configuration.

Preferably, the elongate element is a peripheral elongate band element forming a closed loop having an inwardly directed surface and an outwardly directed surface. More preferably, the elongate element having a width (or equivalently, elongate element height) that is equal to, or less than the height of the largest massage element. Most preferably, the elongate element having a width that is equal to, or greater than one third of the height of the smallest massage element.

Preferably, the closed loop is size adjustable for enabling fitting around the user torso. More preferably, the plurality of massage elements are spaced apart along the elongate element such that each one of the plurality of massage elements can be substantially used in isolation during self-massage by the user.

Preferably, each of the plurality of massage elements are fixedly coupled to the elongate element. More preferably, the plurality of massage elements have an inwardly directed massage portion and an outwardly directed abutment portion opposite the inwardly directed massage portion with respect to the elongate element, such that the inwardly directed massage portion protrudes inwardly from the body and the outwardly directed abutment portion protrudes outwardly from the body.

Preferably, the plurality of massage elements comprises three fixedly coupled massage elements spaced apart along the elongate element. More preferably, the plurality of massage elements including a substantially spherical configuration, a substantially peanut-shaped (e.g. cylindrical or waisted cylindrical) configuration, and a substantially octahedral (pointed) configuration.

Preferably, each massage element has an intermediate sectional plane that defines the massage portion and the abutment portion; each massage element being located such that the closed loop is coupled thereto substantially about the intermediate sectional plane. More preferably, each massage element has a plane of symmetry that defines the massage portion and the abutment portion; each massage element being located such that the closed loop is coupled thereto substantially about the plane of symmetry. Most preferably, one or more massage elements can vary in texture and/or density and/or configuration about the intermediate sectional plane (or plane of symmetry).

According to an aspect of the invention there is provided a massage device for self-massage by a user, the device including:
a body defined by a flexible elongate element adapted to form a closed loop; and
a plurality of massage elements located spaced apart along the elongate element;
each one of the plurality of massage elements having a respectively different configuration;
each of the plurality of massage elements fixedly located along the elongate element;
each of the plurality of massage elements having an inwardly directed massage portion and an outwardly directed abutment portion opposite the inwardly directed massage portion with respect to the elongate element;
the plurality of massage elements are spaced apart along the elongate element such that each one of the plurality of massage elements can be substantially used in isolation during self-massage by the user.

### BRIEF DESCRIPTION OF THE DRAWINGS

A preferred embodiment of the invention will now be described, by way of example only, with reference to the accompanying drawings in which:

FIG. 1 is a perspective view of an embodiment massage device according to the invention;

FIG. 2 is a perspective view of an embodiment massage device according to the invention;

FIG. 3A through FIG. 3C show enlarged partial views of embodiment massage devices, showing embodiment massage elements;

FIG. 4A through FIG. 4C show embodiment massage devices, showing alternative elongate elements; and

FIG. 5A is a perspective view of an embodiment massage device according to the invention.

FIG. 5B is a perspective view of an embodiment massage device according to the invention.

FIG. 6 is a perspective view of an embodiment massage device according to the invention, shown being used for self-massage.

### PREFERRED EMBODIMENT OF THE INVENTION

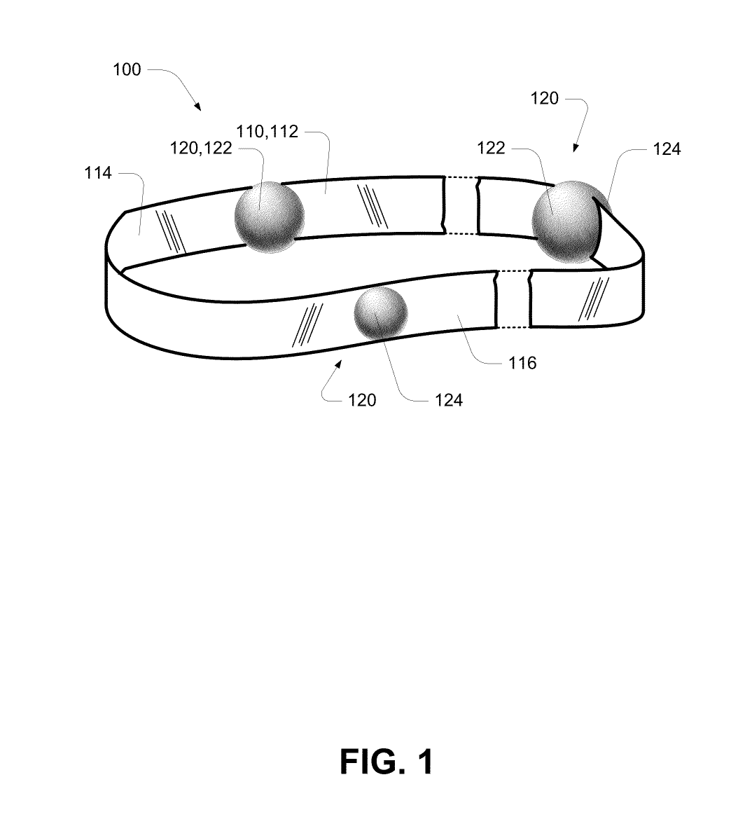

Referring initially to FIG. 1, an embodiment therapeutic massaging device 100 is illustrated for relaxing tightened/stiffened muscles of a user by exerting localized pressures thereon. The operation of the device 100 can be carried out by a user alone.

In this embodiment the massaging device 100, includes:
a body 110 defined by an elongate strap or band element 112 adapted to form a closed loop; and
a plurality of massage elements 120 located spaced apart along the elongate element.

The elongate band element 112 forms a closed loop having an inwardly directed surface 114 and an outwardly directed surface 116. Each of the plurality of massage elements 120 are located to be inwardly directed from the inwardly directed surface.

In this embodiment, each massage element has an inwardly directed massage portion 122 opposite an outwardly directed abutment portion 124 with respect to the elongate element. The outwardly directed abutment portion protrudes outwardly from the body with respect to the loop. The inwardly directed massage portion protrudes inwardly from the body with respect to the loop.

It will be appreciated that the elongate band element can pass through the massage element or between the outwardly directed abutment portion and the inwardly directed massage portion with respect to the elongate element as shown. Alternatively, the outwardly directed abutment portion and the inwardly directed massage portion can be integrally formed with the body or elongate element.

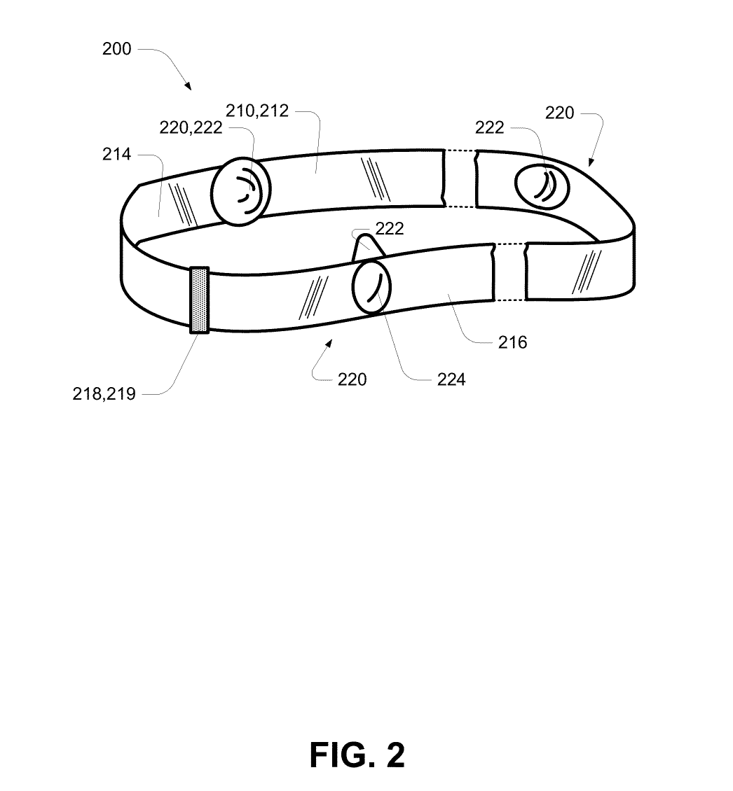

FIG. 2, shows an alternative embodiment massaging device 200. In this embodiment the massaging device 200, includes:
a body 210 defined by a elongate strap or band element 212 adapted to form a closed loop having an inwardly directed surface 214 and an outwardly directed surface 216; wherein cooperating coupling elements 218,219 can be coupled together for adjoining ends of the elongate element to form the closed loop; and
a plurality of massage elements 220 spaced apart along the elongate element.

In this embodiment, each massage element has an inwardly directed massage portion 222 opposite an outwardly directed abutment portion 224 with respect to the elongate element. It will be appreciated that an outwardly directed abutment portion 224 can be used to abut a wall or hard surface such that the user can push against the inwardly directed massage portion 222. Accordingly, it will be further appreciated that outwardly directed abutment portions 224 need not conform to the inwardly directed massage portion 222.

In this embodiment, the body includes a pair of coupling elements 218,219 for adjoining ends of the elongate element to form the closed loop. The ends of the elongate element can be releasably or fixedly adjoined to form the closed loop. By way of example only sides of the elongate element are lined with Velcro™ for securely adjoining ends of the elongate element to form the closed loop

It will be appreciated that, one or more of the plurality of massage elements can be either removably coupled to, or fixedly coupled to, or integrally formed with, the elongate element. It will be further appreciated that being fixedly coupled to can comprise being integrally formed with.

It will be appreciated that, the plurality of massage elements can include massage elements of different sizes and/or shapes. The massage elements can thereby present a massage contact surface having different radii and/or surface area.

It will be appreciated that, the elongate element typically comprises a flexible and/or resilient and/or non-elastic material.

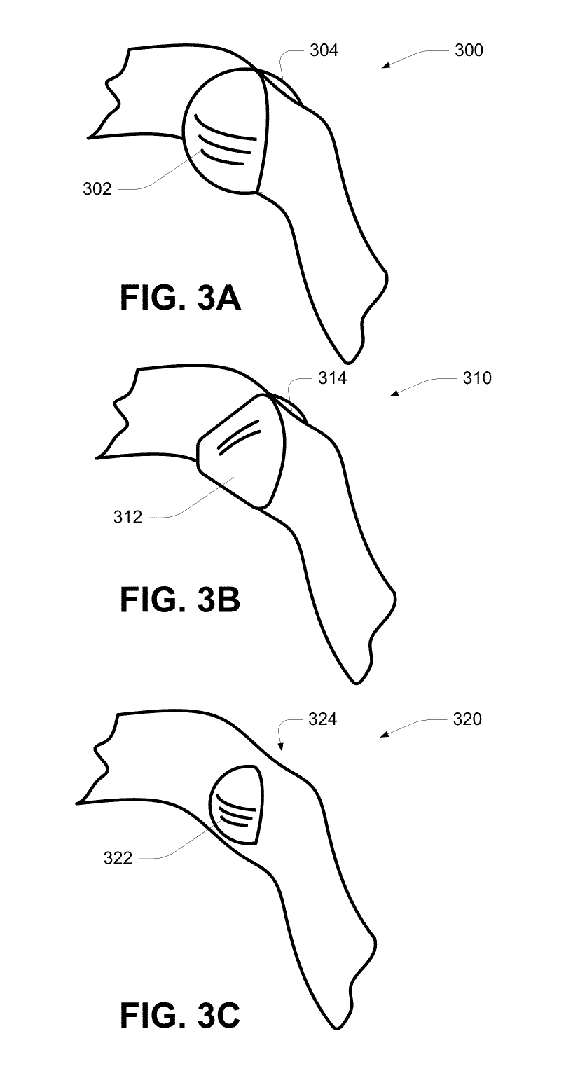

FIG. 3A through FIG. 3C shows selected massage elements (300, 310, 320) by way of example only. From these examples, it will be appreciated that:
massage elements can have alternative locations and/or spacing along an elongate element;
massage elements can be spaced for individual access without interference from other massage elements.
massage elements along an elongate element can each have different shapes and/or sizes and/or configuration and/or density and/or texture;
alternative shapes and/or sizes and/or configuration and/or density and/or texture of inwardly directed massage portions can be included;
alternative shapes and/or sizes and/or configuration and/or density and/or texture of outwardly directed massage portions can be included;
an inwardly directed massage portion, in use, is typically configured to exerting localized pressures to produce a massaging effect on the user;
a massage element contains an inwardly directed massage portion and an outwardly directed abutment portion, defined by the elongate element—such that in use, the outwardly directed massage portion abuts a resilient surface to enable a user to push or roll against the inwardly directed massage portion.

In these example embodiments, FIG. 3A shows a massage element 300 having a substantially hemispherical inwardly directed massage portion 302 and a substantially hemispherical outwardly directed massage portion 304.

In these example embodiments, FIG. 3B shows a massage element 310 having a substantially conical inwardly directed massage portion 312 and a substantially hemispherical outwardly directed massage portion 314. It will be appreciated that the conical massage portion can be used to provide relatively more localized (and deeper) pressure to produce a massaging effect. The edges and/or points of the massage element are suitably smoothed/rounded for use in providing the desired massaging effect.

In these example embodiments, FIG. 3C shows a massage element 320 having a substantially hemispherical inwardly directed massage portion 322 and an outwardly directed massage portion of a suitable configuration 324 (not shown). It will be appreciated that this massage element 320 is relatively smaller than the massage element 300 (referring to FIG. 3A), and can be used to provide a relatively more localized (or specific) pressure to produce a massaging effect or provide a massage effect to a smaller area.

It will be appreciated that, by way of example only, the elongate element can pass through the massage element or between the outwardly directed abutment portion and the inwardly directed massage portion with respect to the elongate element. Alternatively, by way of example only, the inwardly directed massage portion can be integrally formed with the body or elongate element and/or the outwardly directed abutment portion can be integrally formed with the body or elongate element.

It will be appreciated that, as the device massage element has ‘inwardly’ directed portions and ‘outwardly’ directed portions—the roles of the positions can be reversed by turning the elongate element closed loop inside-out. As previously discussed, massage elements can each vary in size and/or shape and/or configuration and/or density and/or firmness and/or surface texture. Accordingly, as the ‘inwardly’ directed portions and ‘outwardly’ directed portions can each be used as a massage portion (by turning the massage device body inside-out) a massage element can vary in shape/configuration and/or density/firmness and/or surface texture about a cross-section substantially co-planar with (or across or parallel to) the elongate element. As this massage element is turned over, it can reveal the respective different shape/configuration and/or density/firmness and/or surface texture. These adaptations may be incorporated in none, or one or more of the massage elements.

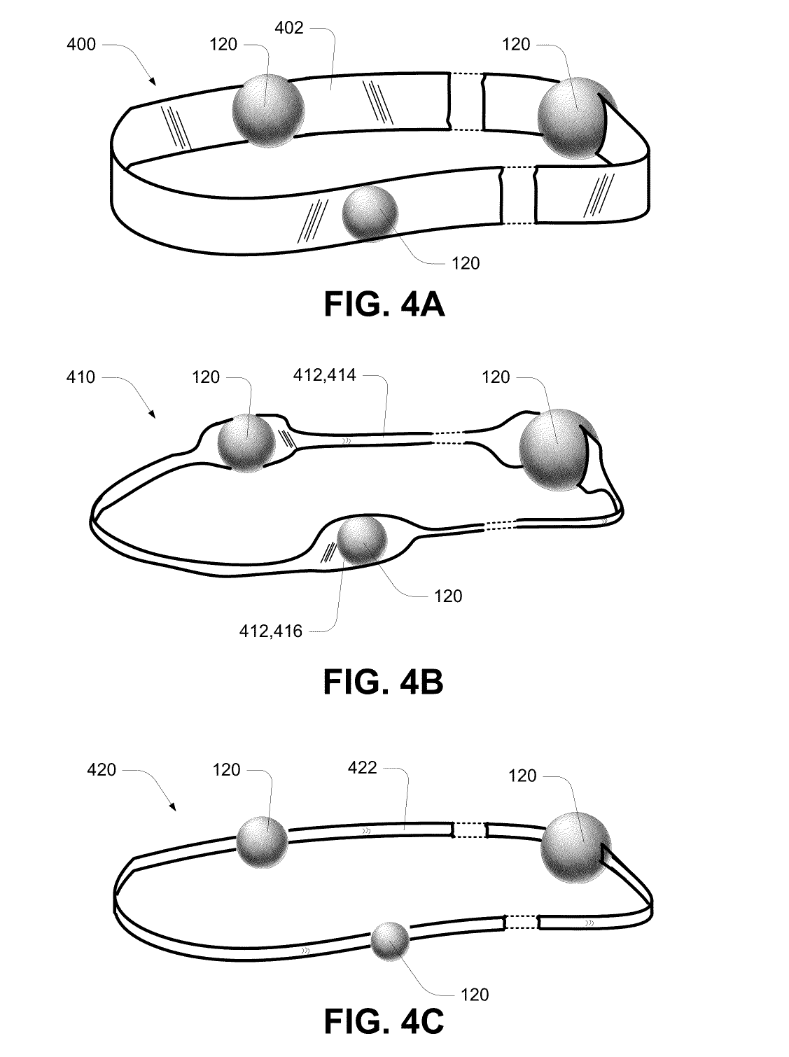

Referring to FIG. 4A through FIG. 4C, elongate elements can have a number of alternative configurations.

FIG. 4A, shows an embodiment massage device 400. In the above examples, and as shown in FIG. 4A, the elongate element 402 is band-like or strap-like. It will be appreciated that locating the massage elements on an inner surface of the band (or strap), such that there is in inwardly directed massage portion, can provide advantages in allowing the user to accurately position the massage portion with improved control over orientations and rotation of the massage element. A massage element having a relatively greater surface area (typically about the midline) attached to the strap, can improve the control that the strap has on positioning the massage element. This advantage is highlighted when locating and retaining a ‘point’ of a massage portion (e.g. a substantially conical or pyramid like massage element) against the user. Also, the greater the surface area of a massage element coupled to the strap, the more evenly force and tension can be distributed through the massage element by the strap (handles).

FIG. 4B, shows an example embodiment massage device 410. It will be appreciated that the elongate element can comprise, by way of example only, interconnected elongate portions (412, 414, 416). The elongate portions 412 including intermediate portions 414 that are substantially restricted in cross section and substantially planar portions 416 that define an inwardly directed surface and an outwardly directed surface for engaging or fixing the massage element (as discussed above).

FIG. 4C, shows an example embodiment massage device 420. It will be appreciated that the elongate element can comprise, by way of example only, comprise a flexible hoop-like (or toroidal) elongate element 422 interconnecting the massage portions.

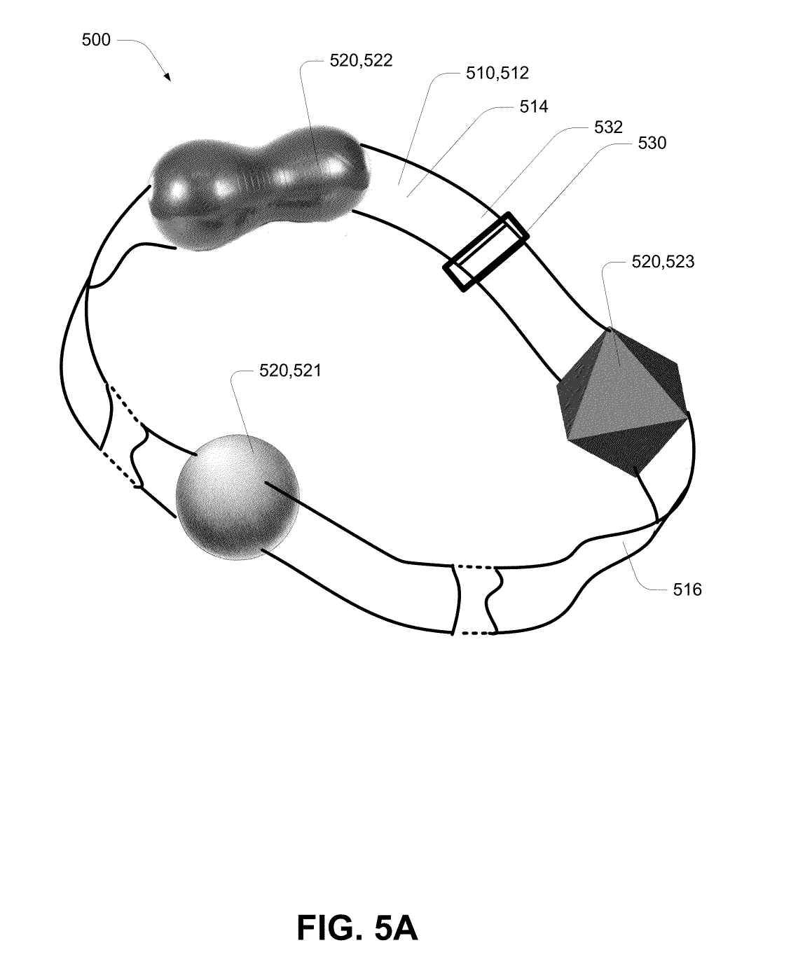

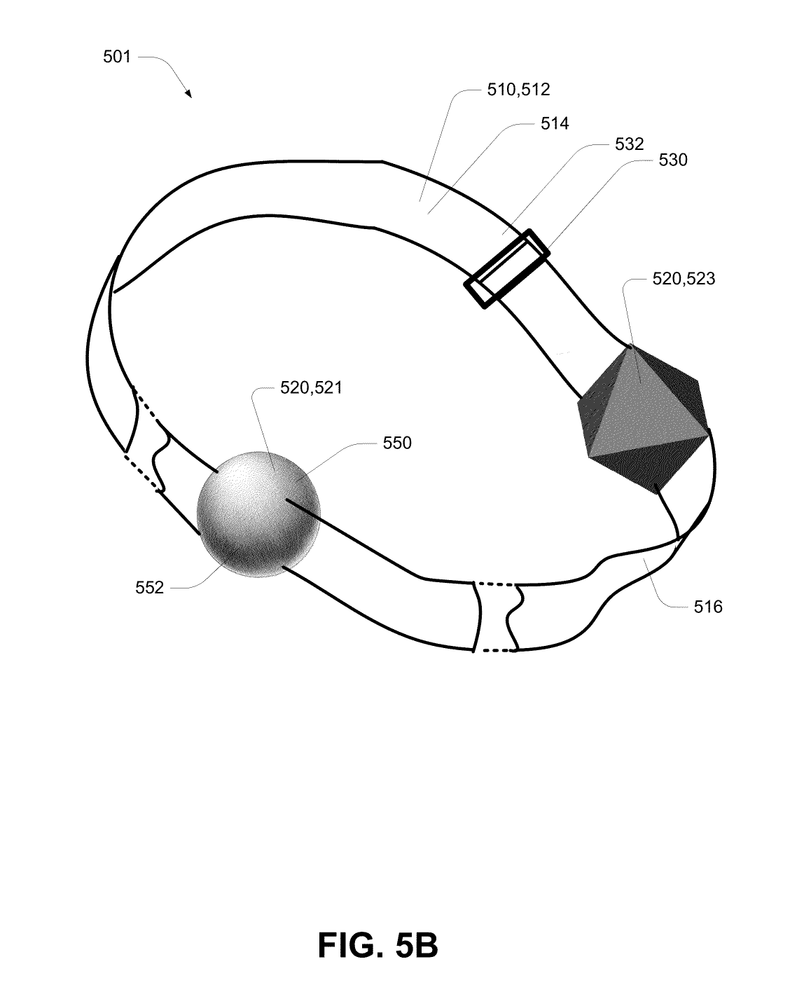

FIG. 5A and FIG. 5B shows an embodiment therapeutic massaging devices 500 and 501 for relaxing tightened/stiffened muscles of a user by exerting localized pressures thereon. The operation of the devices can be carried out by a user alone.

Referring to FIG. 5A, In this embodiment the massaging device 500, includes:
a body 510 defined by an elongate strap or band element 512 adapted to form a closed loop; and
a plurality of massage elements 520 (521, 522, 523) located spaced apart along the elongate element.

In this example embodiment, the massage elements 520 are in the form of a spherical configuration 521, a peanut-like or cylindrical configuration 522 (having a central wasted portion to enable rolling up and down the spine), and an octahedral configuration 523 (typically having rounded edges and/or apexes).

The elongate band element 512 forms a closed loop having an inwardly directed surface 514 and an outwardly directed surface 516.

The elongate band element 512 is typically sized to be greater than half the height of one or more of the massage elements and less than the height of one or more of the massage elements. The massage elements are typically orientated such that, in use, they can be rolled or rocked coaxially with respect to the elongate element.

The elongate band element 512 intersects each massage element substantially about an intermediate sectional plane (for example, including a mid-line or plane of relative symmetry), such that each massage element has a massage portion inwardly directed from the inwardly directed surface, and an abutment portion outwardly directed from the outwardly directed surface. It will also be appreciated that density and/or texture (e.g. smooth, ribbed, spiked) and/or configuration (e.g. shape) of the portions may vary. By way of example, the elongate band element can intersect and pass though each massage element substantially about an intermediate sectional plane and be fixedly coupled thereby.

The elongate band element 512 can include a loop buckle 530 at one end and a fixing 532 (such as Velcro) at the other end. The other end passes though the buckle and is looped back to self adhere, to thereby form a closed loop.

Referring to FIG. 5B, in this embodiment the massaging device 501, includes:
a body 510 defined by an elongate strap or band element 512 adapted to form a closed loop; and
a pair of massage elements 520 (521, 523) located spaced apart along the elongate element.

It will be appreciated that, when in use, the massage element can be located at opposing positions around or along the elongate element.

By way of example only, a substantially spherical massage element 521 can comprise a substantially hemispherical massage portion 550 and a substantially hemispherical abutment portion 552. By way of example only, in an embodiment, the hemispherical massage portion 550 may have a relatively textured surface when compared with the hemispherical abutment portion 552.

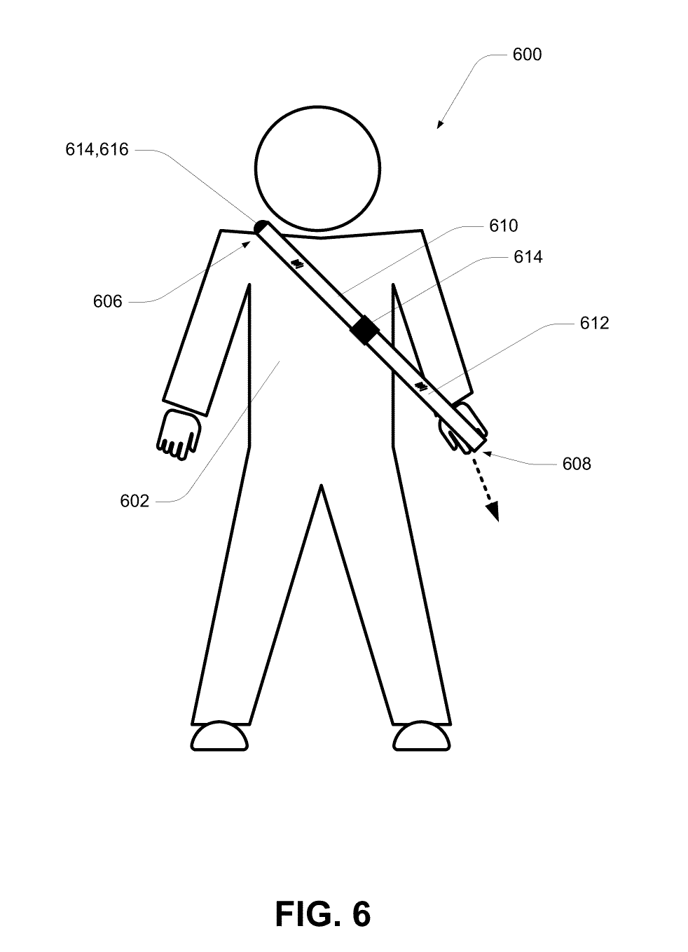

Referring to FIG. 6, a method of using a massage device for self-massage by a user 600, can include the steps of:
(a) providing a massage device 610 including a body 612 forming a closed loop having a plurality of massage elements 614;
(b) locating the body closed loop 612 around the user 600 (for example the user's torso 602);
(c) locating a selected one of the plurality of massage elements 616 at a desired location on the user 600 (for example the user's upper trapezius 606);
(d) applying tension to the body such that the selected massage element is pulled 608 into massage engagement with the location on the user; thereby to produce a massaging effect on the body by exerting localized pressures.

It will be appreciated that pressure can also be applied to the selected one of the plurality of massage elements by rolling and/or pressing it against the wall or floor, such that the selected massage element is pushed into massage engagement with the location on the user; thereby to produce a massaging effect on the user by exerting localized pressures.

It will be appreciated that the closed loop can be sized to fit loosely around the user's torso, and the plurality of massage elements are spaced apart along the elongate element to enable individual (or isolated) access to the selected massage element. The massage device body can encircle a desired location of the user with the selected massage element held, pressed against or pulled into the selected location on the user so as to produce a massaging effect thereon.

It will be appreciated that those skilled in the art will recognize that other and further modifications may be made thereto without departing from the spirit of the invention. Further embodiments of the massage device (and methods of use) will be taught by way of example only.

In an embodiment, a massage device includes a flexible (non-rigid) continuous loop with a plurality of different shaped and/or sized and/or density/hardness and/or textured massage element protrusions fixed around it. The protrusions are sufficiently spaced (for example more than 20 cm from each other) so they can be used in isolation from each other without interference. The entire loop is large enough to encircle the user's body (for example greater than 80 cm). The shape of protrusions may be selected from ‘balls’ (spherical/hemispherical/segment of a sphere), ‘rollers’ (cylindrical—being contoured or ribbed or smooth), ‘peanut’ shapes, ‘pointed’ shape (conical/pyramid). The shapes may vary in hardness/density and/or size and/or surface texture. In an embodiment, no two protrusions are identical.

It will be appreciated that, for the purpose of self massage the device can apply pressure and friction to various parts of the body, particularly muscles and soft tissue. The pressure and friction applied to the muscles and soft tissue, simulates manual therapy treatments, such as massage. In particular the contrasting massage styles, of Myofascial Release massage (general broader surface area, working on fascia and connective tissue) and Trigger Point massage (more specific, deeper points within muscles). The massage device, in particular the closed loop body element, may also be used to facilitate the stretching of muscles.

It will be appreciated that having massage elements fixedly coupled about the midline, to the elongate body enables the user to have greater control over the position, pressure and friction of massage elements with reduced slippage. Being fixedly coupled allows the massage element to be used in a number of orientations and directions. It will be further appreciated that the wider the strap, in relation to the height of the massage element coupled to it, the greater the effect the strap will have on controlling and distributing its force throughout the massage element. Also, the user has direct access to the massage element, taking advantage of the surface texture. For example, the friction of the massage element or the addition of ‘spikes’ to the surface (for stimulating various acupressure points).

The massage device, in use, can be located such that a protrusion engages the area on the user requiring relief. The user then applies pressure to the protrusion by leaning on a wall, lying on the floor, or pulling on the device loop to apply tension. Friction can be created by rolling and moving the protrusion back and forth whilst under tension and pressure.

It will be appreciated that by a massage device having protrusions of various sizes and configuration, the device can be used to locate and massage different sized muscles and soft tissue areas. The different protrusions accommodate personal pressure requirements and allow maneuverability around bony structures significantly increasing access. The user has a greater control over the pressure and intensity applied to muscles, by selecting a protrusion of suitable surface area (shape and size) and/or hardness. For example, the top layers of a muscle can be released (Myofascial release massage), before specifically targeting points deeper in the muscle (Trigger Point massage). This massage device accommodates different styles of massage, body shapes and sizes, and individual needs.

It will be appreciated that closed loop design allows each protrusion to have two equal ‘handles’ which are used to accurately position the relevant protrusion onto massage location. The ‘handles’ can also be used to create the tension, pressure and friction applied to the muscle area. Being a closed loop allows the ‘two handles’ to be tensioned and controlled together. The user can tension the entire loop with just one hand, pulling a selected protrusion into the soft tissue. This allows the muscles being massaged to remain relaxed and decreases the effort required for effective relief.

The soft, smooth and flexible loop can be sized to cross over one shoulder (or around the body) of a user, so the relevant protrusion can be positioned onto the selected muscle. The loop can be slung over the shoulder when leaning against a wall, so the protrusion being used to create the massaging pressure and friction does not fall to the ground when pressure is stopped.

The non-rigid flexible ‘handles’ defined by the closed loop elongate element are comfortable to lie on without bruising the soft tissue (and bony structures) of the user. A soft substantially smooth planar looped massage device body does not interfere with the protrusions. Also the flexibility of the loop enhances the massage device, by improving the ability to reach, wrap and manoeuvre protrusions over and around the user. The flexible loop can be used to locate protrusions to muscles around the user with ease and comfort, as it comfortably bends, rolls, twists and conforms to the curves of the user.

The user can alternate between different protrusions, by simply sliding the loop along or turning over, without changing their working position. This allows less effort and means the muscle being worked on can stay relaxed. The user can effectively massage many different parts of the body with this one massage device.

The loop can also be used to facilitate the stretching of some muscles, like hamstrings.

An embodiment massage device, by way of example only, can include:
an elongate element about 4 cm wide and about 140 cm in length, buckled into a loop;
3 spherical massage elements spaced approximately 40 cm from each other; the massage elements being fixed and/or sewn to the elongate element; the massage elements having diameters 4 cm, 6 cm and 8 cm respectively; each massage element being formed of plastics or rubber.

It will be appreciated that variations can include (by way of example only) any one or more of the following:
the elongate element width;
the elongate element length;
the elongate element thickness;
the elongate element can include a length adjustment means for shortening or extending the length of the elongate element;
the elongate element can include a length adjustment element such as an extension portion, Velcro™, or buckle adjustment for shortening or extending the length of the elongate element—the length adjustment element can be included in the loop between one or more (or each) of the massage elements;
the elongate element material used can include cotton, synthetic, polyester webbing, rubber, plastic, neoprene, or silicone;
the elongate element loop may be openable, creating two unattached ends
the massage elements number;
the massage elements inter-distances;
the massage elements size;
the massage elements shape;
the massage element diameters;
the massage element density/hardness;
the massage element surface texture;
the massage element material used can include wood, plastics, rubber, dense foam, or silicone;
the massage element can be formed of different materials and/or have different surface textures to provide respectively different amounts of friction with the user's skin and/or clothing;
each massage element can be shaped suitable for massage including: a roller (cylinder) shape, peanut shape, or pointed shape (conical/pyramid);
the massage element can comprise two portions (substantially about a mid-line—typically being about the elongate body) that vary in shape and/or density and/or texture.
the massage device can be integrally formed for example one piece of moulded plastics or rubber.

It will be appreciated that the disclosed massage device can provide a user with any one or more of the following advantages:
ease of use—by enabling massage elements to be interchanged/selected without the user changing position and without assembly—through sliding the loop around to access the selected massage element;
the closed loop may be configured “inside-out” for accessing the opposite portion of a massage element by turning the strap/band over;
direct unencumbered access can be had to the massage element surface texture and shape;
the closed loop allows each massage element to have two ‘handles’;
the closed loop band/strap is smooth and flexible so it is comfortable to lie on and will not create ‘rope burn’ as it is tensioned or rubs against the skin;
the closed loop is smooth and flexible so it can twist and fold for enabling rolling of massage elements and increases access to muscles;
the closed loop is adjustable for adapting to a user's body size;
the closed loop is sized to be positioned over and around a user—increasing access of massage elements to various muscles;
massage pressure and positioning can be applied with minimal effort;
the closed loop allows one handed tension (massage pressure) to be created;
the closed loop slung across a user, enables the user to apply pressure using the arm on the other side while the side being massaged/released stays relaxed;
fixedly coupled massage elements increases the number of directions the handles can be pulled on effectively, which increases the number of directions friction can be applied to muscle fibres under pressure;
having a plurality of massage elements of different sizes and configurations supports use by user's of different shapes and sizes;
having a plurality of massage elements of different sizes and configurations supports use by a user across different massage types and locations;
the device is portable;
the device need not require assembly;
the device need not have moving parts;
the device can be washable and hygienic;
the device (depending on materials used to construct the device) can be used with or without oil, on skin or over clothing, in the bath, shower, steam room and sauna;
the device need not require electrical cords or batteries.
the elongate loop element having a width (or height) that is greater than one third of the height of the massage element will increase the effect the loop element has on the massage element with the use of the ‘handles’;
the width of the loop elongate element being equal to or less than the height of a massage element, will enable unencumbered rolling of the massage element (particularly, coaxially about the elongate body).
the loop band elongate element when tensioned will restrict the massage element from moving and when strap is relaxed, will allow for rolling.
The strap/band elongate element may define the massage portion and the abutment portion of a massage element, such that in use, the elongate body controls and separates access to the two varied portions of a massage element; wherein, for example, a smooth hemispherical portion being opposite a ‘spiky’ hemispherical portion, coupled to the elongate band to form a relatively spherical massage element.
Massage elements fixedly coupled to the elongate element increases user ability to locate and maintain pressure on selected points within a muscle.
The elongate band element evenly distributes its force throughout the coupled massage element.

It will be appreciated that an illustrated embodiment provides a massage device that can be used to perform self-massage.

It will be appreciated that increased elongate loop band element width (or equivalently, band element height) when coupled a massage element can increases the user's control over that massage element, with the use of the massage elements ‘handles’. For example, an octahedron coupled to the band element about the intermediate sectional plane of relative symmetry. Where the inward massage portion and the outward abutment portion each consists of a five sided (square) pyramid. Where the square base of each of the five sided pyramids is effectively coupled to the band element (symmetrically opposite the other). As each base sits squarely on the band, two sides of each square base are located parallel with the sides of the band and two sides of each base are located horizontally to the sides of the band (the horizontal sides represent the height of the massage element). It will be noted that as the elongate element band width increases, in relation to the length of the (horizontally located) sides of the square base(s), it will significantly increase the effect the strap has on controlling the point of the five sided pyramid(s).

It will be appreciated that an illustrated embodiment can provide a hands-free therapeutic massaging device that can produce a massaging effect on the body by exerting localized pressure. It will be appreciated that an illustrated embodiment can provide a therapeutic massaging device that employs a plurality of massage elements coupled to a closed loop, which allows each of the massage elements to be used in isolation—thereby reducing the need to adjust massage elements directly with respect to the position on the body, as the strap encircles the body.

Although the invention has been described with reference to specific examples, it will be appreciated by those skilled in the art that the invention may be embodied in many other forms.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noted that the term coupled, when used in the claims, should not be interpreted as being limitative to direct connections only. The terms “coupled” and “connected”, along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical contact, or that two or more elements are not in direct contact with each other but yet still co-operate or interact with each other.

Similarly, it is to be noted that the term configuration can includes any one or more of the following: size, shape, surface texture, density/firmness, orientation. A change in configuration or shape may occur when surface texture is altered, for example adding spikes or bumps to a smooth surface.

Similarly, it is to be noted that the term configuration ‘height’ of a massage element is measured with respect to the height (or equivalently width) of an associated elongate band element. The height of a massage element is usually measured at an intermediate sectional plane (typically defining a plane of substantially relative symmetry) of a massage element, which typically defines the inwardly directed massage portion from the outwardly directed abutment portion. The relative height is typically measured proximal to the intersection of the massage element and associated elongate band element.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

As used herein, unless otherwise specified the use of terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader, or with reference to the orientation of the structure during nominal use, as appropriate. Similarly, the terms “inwardly” and “outwardly” generally refer to the orientation of a surface relative to its axis of elongation, or axis of rotation, as appropriate.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

It will be appreciated that an embodiment of the invention can consist essentially of features disclosed herein. Alternatively, an embodiment of the invention can consist of features disclosed herein. The invention illustratively disclosed herein suitably may be practiced in the absence of any element which is not specifically disclosed herein.

1. The massage device for use in self-massage by a user, the device including:
a flexible elongate body element;
a least one substantially spherical massage element coupled to the elongate element;
each massage element located along the elongate element such that a first massage element can be substantially used in isolation during self-massage by the user;
the at least one substantially spherical massage element having a first massage contact surface and a second massage contact surface; the first massage contact surface and the second massage contact surface being located on opposite regions of the massage element; wherein surface texture of the first massage contact surface is different to surface texture of the second massage contact surface;
the elongate element being coupled to each massage element about opposite sides of the respective massage element between the first massage contact surface and second massage contact surface;
wherein, in use, either the first massage contact surface or the second massage contact surface of the first massage element can be selected to exert a localized pressure on the user for produce a massaging effect.

2. The massage device according to claim 1, wherein
the body element is an elongate band element having first band surface and an oppositely directed second band surface, the elongate element having a width less than the height of each massage element;
each massage element having an intermediate sectional plane that defines the first massage contact surface and the second massage contact surface; the body element being coupled to each massage element substantially about the intermediate sectional plane;
each massage element has the respective first massage contact surface protruding from the first band surface and the respective second massage contact surface protruding from the second band surface;
wherein, by reversing the band, a user selectively presents either the first massage contact surface or the second massage contact surface.

3. The massage device according to claim 2, wherein a massage element coupled to the elongate element has the respective first massage contact surface and the respective second massage contact surface comprising different configurations.

4. The massage device according to claim 2, wherein each massage element coupled to the elongate element has the respective first massage contact surface and the respective second massage contact surface comprising different textures.

5. The massage device according to claim 4, wherein each massage element is fixedly coupled to the elongate element.

6. The massage device according to claim 2, including:
a plurality of massage elements; each of the plurality of massage elements having a different configuration; and
the plurality of massage elements being located along the elongate element, such that each massage element can be substantially used in isolation during self-massage by the user.

7. The massage device according to claim 2, including:
a plurality of massage elements; each of the plurality of massage elements having a different surface texture; and
the plurality of massage elements being located along the elongate element, such that each massage element can be substantially used in isolation during self-massage by the user.

8. The massage device according to claim 2, wherein the elongate band element has a width that is less than the diameter of each massage element and greater than one-third the diameter of each massage elements.

9. The massage device according to claim 2, wherein ends of the flexible elongate body element have co-operating coupling elements; wherein with the co-operating coupling elements contacted the flexible elongate body element forms a size adjustable flexible closed loop.

10. The massage device according to claim 9, wherein the closed loop is size adjustable for enabling fitting around a torso of the user.

11. The massage device for use in self-massage by a user, the device including:
a flexible elongate body element;
one or more of massage element coupled to the elongate element; each massage element located along the elongate element such that a first massage element can be substantially used in isolation during self-massage by the user; each massage element having a first massage contact surface and a second massage contact surface; the first massage contact surface and the second massage contact surface being located on opposite regions of the massage element;
the elongate element being coupled to each massage element about opposite sides of the respective massage element between the first massage contact surface and second massage contact surface;
the body element being an elongate band element having first band surface and an oppositely directed second band surface, the elongate element having a width less than the height of each massage element;
each massage element having an intermediate sectional plane that defines the first massage contact surface and the second massage contact surface; the body element being coupled to each massage element substantially about the intermediate sectional plane;
each massage element has the respective first massage contact surface protruding from the first band surface and the respective second massage contact surface protruding from the second band surface;
wherein, in use, either the first massage contact surface or the second massage contact surface of one massage element can be selected to exert a localized pressure on the user for produce a massaging effect; and wherein, by reversing the band, the user selectively presents either the first massage contact surface or the second massage contact surface.

12. The massage device according to claim 11, wherein the first massage contact surface and the second massage contact surface of each massage element have a different configuration.

13. The massage device according to claim 12, wherein the first massage contact surface and the second massage contact surface of each massage element have a different surface texture.

14. The massage device according to claim 13, wherein each massage element is fixedly coupled to the elongate element.

15. The massage device according to claim 13, wherein ends of the flexible elongate body element have co-operating coupling elements; wherein with the co-operating coupling elements contacted the flexible elongate body element forms a size adjustable flexible closed loop.

16. The massage device according to claim 11, wherein the first massage contact surface and the second massage contact surface of each massage element have a different surface texture.

17. The massage device according to claim 16, wherein each massage element is fixedly coupled to the elongate element.

18. The massage device according to claim 16, wherein ends of the flexible elongate body element have co-operating coupling elements; wherein with the co-operating coupling elements contacted the flexible elongate body element forms a size adjustable flexible closed loop.
